(19) United States
(12) Patent Application Publication
(10) Pub. No.: US 2025/0284849 A1
(43) Pub. Date: Sep. 11, 2025

(54) FACTORIZED DIGITAL COMPONENT SELECTION

(71) Applicant: Google LLC, Mountain View, CA (US)

(72) Inventor: Tenghui Liu, Sunnyvale, CA (US)

(21) Appl. No.: 18/858,978

(22) PCT Filed: Mar. 17, 2023
(86) PCT No.: PCT/US2023/015500

§ 371 Date: Oct. 22, 2024

(51) Int. Cl. G06F 21/62

(52) U.S. Cl. CPC G06F 21/6263; G06F 21/6236

(57) ABSTRACT

Methods, systems, and apparatus, including computer programs encoded on a computer storage medium, for digital component selection are described. In one aspect, a method includes receiving, by a trusted computing device and across a trust boundary, digital component selection factors that each correspond to a digital component. The trust boundary defines computing devices which can access private user data without the private user data being transmitted to untrusted third party devices. In response to receiving a request for a digital component, the trusted computing device transmits a non-private contextual request that includes request data and information about generating a user data factor. The trusted computing device receives a contextual response that includes a contextual selection factor that corresponds to the information about generating the user data factor, and selects a digital component based on the corresponding digital component selection factors, the received contextual selection factor, and the user data factor.

### TECHNICAL FIELD

This specification is related to data processing, data privacy, and data security.

### BACKGROUND

Data security and user privacy are vital in systems and devices connected to public networks, such as the Internet. Concerns about user privacy have led many developers to change the ways in which user data is handled. For example, some browser developers are planning to deprecate the use of third-party cookies.

### SUMMARY

Privacy is a significant concern with user data on devices connected to any network. One method of maintaining user privacy is by maintaining user data only on a user device during the process of content serving (for example, ad serving). However, it can be difficult to perform full model prediction for content serving using only user devices in a scalable way while preserving user privacy. User devices may have limited computation resources and may not be able to run the models used on servers. User devices may lack specific hardware, such as Tensor Processing Units (TPUs), which can be used by servers to predict and serve content. Lightweight models may be used as an alternative to full models to perform predictions on user devices. However, lightweight models have tradeoffs with model accuracy, device power consumption, and latency at serving time. Lightweight models are simplified and do not offer as many features as models used by servers. Full model prediction can use thousands of features received from various computing systems, such as features relating to content requests and features relating to candidate content. For example, full prediction models can use targeting signals for prediction. As a result, historically, lightweight models are less accurate at performing predictions for content serving.

To address these issues, factorized models can be used to perform predictions while maintaining user privacy. Predictions can be performed on the user device by using a combination of server generated embeddings and locally generated embeddings. The embeddings can include user embeddings, ad embeddings, and/or query embeddings. The factorized models increase efficiency as compared with online server side models. Factorized models allow ad embeddings to be predicted before ads are requested. During real-time ad serving, predictions can be performed quickly using the pre-generated embeddings without requiring the collection of a large number of features and complex processing of the features. The predictions can be generated by performing simple calculations using the embeddings.

In general, one innovative aspect of the subject matter described in this specification can be embodied in methods including the operations of receiving, by a client device and from multiple content platforms across a trust boundary, a plurality of digital component selection factors that each correspond to a digital component of a plurality of digital components, wherein the trust boundary defines one or more computing devices which can access private user data without the private user data being transmitted to untrusted third party devices; receiving, by the client device, a request for a digital component for presentation at the client device, wherein the request includes request data; generating, by the client device, a user data factor based on the request for the digital component; in response to receiving the request for the digital component, transmitting, by the client device and to at least one of the multiple content platforms across the trust boundary, a non-private contextual request that includes the request data and information about generating the user data factor; after transmitting the non-private contextual request, receiving, by the client device and from the at least one of the multiple content platforms across the trust boundary, a contextual response that includes a contextual selection factor that corresponds to the information about generating the user data factor; selecting, by the client device, one of the plurality of the digital components based on the corresponding digital component selection factors, the received contextual selection factor, and the user data factor, wherein the user data factor remains private and does not cross the trust boundary; and providing, by the client device, the selected one of the digital components for presentation. Other implementations of this aspect include corresponding apparatus, systems, and computer programs, configured to perform the aspects of the methods, encoded on computer storage devices.

In general, one innovative aspect of the subject matter described in this specification can be embodied in methods including the operations of receiving, by at least one trusted computing device and from multiple content platforms across a trust boundary, a plurality of digital component selection factors that each correspond to a digital component of a plurality of digital components, wherein the trust boundary defines one or more computing devices which can access private user data without the private user data being transmitted to untrusted third party devices; receiving, by the at least one trusted computing device, a request for a digital component for presentation at a client device, wherein the request includes request data; generating, by the at least one trusted computing device, a user data factor based on the request for the digital component; in response to receiving the request for the digital component, transmitting, by the at least one trusted computing device and to at least one of the multiple content platforms across the trust boundary, a non-private contextual request that includes the request data and information about generating the user data factor; after transmitting the non-private contextual request, receiving, by the at least one trusted computing device and from the at least one of the multiple content platforms across the trust boundary, a contextual response that includes a contextual selection factor that corresponds to the information about generating the user data factor; selecting, by the at least one trusted computing device, one of the plurality of the digital components based on the corresponding digital component selection factors, the received contextual selection factor, and the user data factor, wherein the user data factor remains private and does not cross the trust boundary; and providing, by the at least one trusted computing device, the selected one of the digital components for presentation. Other implementations of this aspect include corresponding apparatus, systems, and computer programs, configured to perform the aspects of the methods, encoded on computer storage devices.

These and other implementations can each optionally include one or more of the following features. In some aspects, the information about generating the user data factor includes a version number determined based on the user data factor.

In some aspects, the user data factor is generated by a trained machine learning model using information from the digital component request.

In some aspects, the trained machine learning model is trained at least in part on the client device using historical user data.

In some aspects, the trained machine learning model is collaboratively trained with at least one other client device and the historical user data remains on the client device.

In some aspects, selecting one of the digital components includes: for each of the digital components, generating a score based on the corresponding digital component selection factors, the contextual selection factor, and the user data factor; and selecting the digital component with the greatest score.

In some aspects, the digital component selection factor, the contextual selection factor, and the user data factor each includes embedding vectors of equal dimensions.

Particular embodiments of the subject matter described in this specification can be implemented so as to realize one or more of the following advantages. Selecting digital components in a trusted environment enables such selection to be performed based on sensitive user data without the data being disclosed to other parties and enables personalization of the content, even after third party cookies are deprecated and other privacy enhancements are implemented. User privacy can be further preserved by preventing content platforms that provide digital content to learn that the content is being provided to a particular user or the user's device. For example, this obviates the need for the user's device to download a discrete content element for a digital component based on a Universal Resource Locator (URL) or Universal Resource Identifier (URI) provided to the device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a trusted server distributes digital components to client devices in a privacy preserving manner.

FIG. 2 is a block diagram of an example environment in which a client device selects digital components.

FIG. 3 is a block diagram of a first example environment in which a trusted server distributes digital components to client devices in a privacy preserving manner.

FIG. 4 is a block diagram of a second example environment in which a trusted server distributes digital components to client devices in a privacy preserving manner.

FIG. 5 is a flow diagram of an example process for selecting and providing a digital component for display at a client device in a privacy preserving manner.

FIG. 6 is a block diagram of an example computer system.

Like reference numbers and designations in the various drawings indicate like elements.

### DETAILED DESCRIPTION

In general, this document describes systems and techniques for selecting and distributing digital components to client devices in ways that protect user privacy and confidential data of content platforms and/or digital component providers. A trusted server can be configured to perform digital component selection processes that use sensitive user data so that the user data is not provided to any other entity. The trusted server can host and execute selection logic of various content platforms when selecting digital components based on user data in manners that ensure that no other entity can access the selection logic of the content platform. In this way, both the data of the users and the content platforms is kept secure.

Factorized models can be used for on-device ad serving while keeping embeddings of the factorized models synchronized between the device and server systems. The factorized models can represents complex distributions by breaking them down into simpler, more manageable parts. Factorized models can decompose a joint distribution over multiple variables into a product of simpler conditional distributions over subsets of the variables. These subsets are typically chosen to capture dependencies among relevant variables. Factorized models can be less complex than other models, as they represent the joint distribution using simpler, modular parts. For example, factorized models can break down the joint distribution into simpler parts. By breaking down complex distributions into simpler parts, factorized models can be trained more efficiently and can provide more interpretable results than non-factorized models. Factorized models differ from other models in the way they represent and learn the joint distribution of variables.

The factorized models can include two tower models and/or three tower models, in which each tower includes different embeddings. The server systems can generate ad embeddings in advance before ads are requested. At serving time, the device can predict user embedding using a trained machine learning (ML) model, and determine a version number of the factorized model (e.g., the models can be updated periodically). The server system can receive a contextual request from the device. The contextual request can include the version number of the factorized model. The server system can determine query embeddings based on the version of the factorized model and transmit the query embeddings back to the device. The device can fetch the corresponding version of embeddings for ad candidates (e.g., the ad candidates can be preloaded from the server system).

Ad predictions can be performed on the device without requiring specific hardware (e.g., TPUs) while maintaining similar performance (e.g., ad serving quality) to server side predictions. Model quality can be preserved while reducing serving power cost and latency. Privacy can be maintained for personal user data because the data does not need to be sent to servers maintained by third parties (e.g., non-trusted servers). Personal user data can remain in a trusted environment. The ability to provide relevant content to the particular user can remain unchanged, while maintaining user privacy.

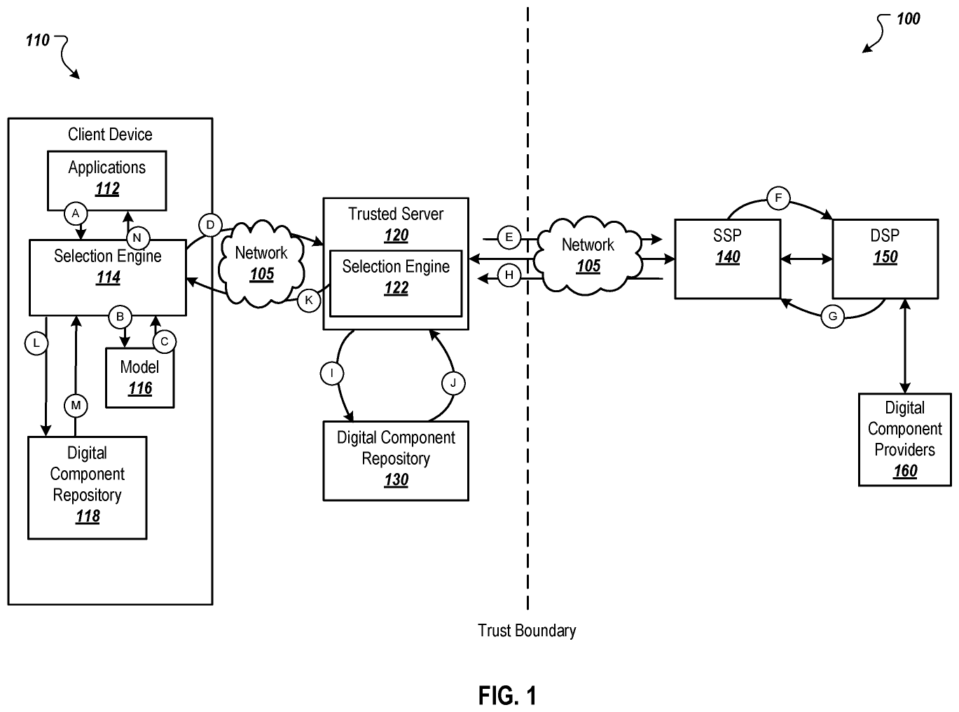

FIG. 1 is a block diagram of an example environment 100 in which a client device 110 provides digital components in a privacy preserving manner. The environment 100 includes a data communication network 105, such as a local area network (LAN), a wide area network (WAN), the Internet, a mobile network, or a combination thereof. The data communication network 105 connects client devices 110 to the trusted server 120 and connects the trusted server 120 to content platforms, such as supply side platforms (SSPs) 140 and/or demand side platforms (DSPs) 150. The network 105 can also connect the various content platforms to one another and/or to digital component providers 160, e.g., to servers of the digital component providers 160.

A client device 110 is an electronic device that is capable of communicating over the network 105. Example client devices 110 include personal computers, server computers, mobile communication devices (e.g., smart phones and/or tablet computers), and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including, a wearable device (e.g., watch or glasses), a smart phone, a speaker device, a tablet device, or another hardware device. A client device can also include a digital media device, e.g., a streaming device that plugs into a television or other display to stream videos to the television, a gaming system, or a virtual reality system.

A client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources (e.g., web pages, application pages, or other application content) to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of this document, a resource can refer to a web page, application page, application content presented by a native application, electronic document, audio stream, video stream, or other appropriate type of electronic resource with which a digital component can be presented.

As used throughout this document, the phrase “digital component” refers to a discrete unit of digital content or digital information (e.g., a video clip, audio clip, multimedia clip, image, text, or another unit of content). A digital component can be electronically stored in a physical memory device as a single file or in a collection of files, and digital components can take the form of video files, audio files, multimedia files, image files, or text files and include advertising information, such that an advertisement is a type of digital component. For example, the digital component may be content that is intended to supplement content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

As described in more detail below, a client device 110 can include selection engine 114 to select a digital component to provide to the application 112 for presentation in the digital component slot. The selection engine 114 can select a digital component from a set of digital components stored in a digital component repository 118 and/or a set of digital components received from the trusted server 120.

In some implementations, the selection engine 114 can include a factorized model. The factorized model can include a three tower model which uses a digital component selection factor, a contextual selection factor, and a user data factor. For example, the digital component selection factor, the contextual selection factor, and the user data factor can each include an embedding vector (e.g., a vector of floats with different dimensions). A factorized retrieval process can be performed when retrieving digital components, based on the three tower model. The selection engine 114 can determine, for each digital component, a corresponding dot product of the embedding vectors. Each of the dot products can be associated with the corresponding digital component (e.g., as metadata), for use in the selection processes. In general, computing the dot product can be a fast computation, and can be performed with fewer computing resources than would be used if directly employing a machine learning model.

The metadata for a digital component can include, for example, distribution criteria that defines the situations in which the digital component is eligible to be provided to a client device 110 in response to a digital component request received from the client device 110 and/or a selection parameter that indicates an amount that will be provided to the publisher if the digital component is displayed with a resource of the publisher and/or interacted with by a user when presented. For example, the distribution criteria for a digital component can include location information indicating which geographic locations that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). Other data that can be used to select a digital component can also be stored in the digital component repository with a reference (e.g., a link or as metadata) to its digital component.

The client device 110 can include a model 116 to generate user data factors using information from the digital component request. User features can be the most critical features in ads serving. The model 116 can include a trained machine learning (ML) model. The model 116 can be trained using on-device sensitive user data with collaborative learning, for example, federated learning. Federated learning can allow multiple devices to collaboratively learn a shared model while keeping the training data on the devices. In some implementations, the model 116 can be trained at a server, and transmitted to the client device 110. For example, the model 116 can be trained at the SSP 140 or the DSP 150 using user data in a private way (e.g., anonymized), and served to the client device 110. Version redundancy of user data factors can be used when user data factors are prefetched onto devices. In some implementations, the user data factors can include user embeddings. For example, user embedding can be based on the user's age, user's gender, geolocation, the IP address, and/or a user history (e.g., what websites the user has visited, what the user has bought in the past, personal interests, such as music interests).

The client device 110 can use sensitive user data as an input to generate the user data factors. The sensitive user data can include, for example, data identifying user groups that include the user as a member. The user groups can include interest-based groups. Each interest-based group can include a topic of interest and a set of members identified (e.g., determined or predicted) to be interested in the topic. The user groups can also include, for example, groups of users that performed particular actions at electronic resources (e.g., websites or native applications) of publishers. For example, a user group can include users that visited a website, users that requested more information about an item, interacted with (e.g., selected) a particular digital component and/or added an item to a virtual cart to potentially acquire the item. The user data for a user can also include user profile data and/or attributes of the user.

Further to the descriptions throughout this document, a user may be provided with controls (e.g., user interface elements with which a user can interact using hardware devices such as display, keyboard, touchpads, touch screens, mouse, joysticks, etc.) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The digital component repository 118 can store digital components received from the trusted server 120 and additional data (e.g., metadata) for each digital component. The digital component repository 118 can store digital component selection factors that each correspond to a digital component of a plurality of digital components. The digital component selection factors can be predicted before a digital component is requested. The corresponding digital component selection factors can include query embeddings. The digital component repository 118 can be synchronized with the digital component repository 130.

An example process for selecting and providing a digital component for presentation at a client device 110 is illustrated in stages A to N, which illustrate a flow of data between the components of the environment 100.

In stage A, the application 112 running on the client device 110 sends a request for a digital component to the selection engine 114 running on the client device 110. When the application 112 loads a resource that includes a digital component slot, the application 112 can generate a digital component request that requests a digital component for presentation in the digital component slot. In some implementations, the digital component slot and/or the resource can include code (e.g., scripts) that cause the application 112 to request a digital component from a selection engine 114.

A digital component request can include contextual data, which is generally considered non-sensitive. The contextual data can describe the environment in which a selected digital component will be presented. The contextual data can include, for example, coarse location information indicating a general location of the client device 110, a resource (e.g., website or native application) with which the selected digital component will be presented, a spoken language setting of the application 112 or client device 110, the number of digital component slots in which digital components will be presented with the resource, the types of digital component slots, and other appropriate contextual information.

In stage B, the selection engine 114 sends a request for a user data factor to the model 116. The request for a user data factor can include the contextual data and/or sensitive user data. The model 116 can generate a user data factor based on the request for the digital component. The user data factor can be inferenced on the client device 110 with user signals available only on the client device 110. The inference can happen on demand or periodically. For example, the user data factor can be generated after the request for the digital component is received. In some examples, the user data factor can be generated before the contextual response is received.

In stage C, the selection engine 114 receives a user data factor. The selection engine 114 can store the user data factor (e.g., in a memory and/or cache of the client device 110) while the digital component selection factor and the contextual selection factor are received. In some implementations, the selection engine 114 receives a version of the model 116. In some implementations, the client device 110 can determine a version number of the model 116 (for example, the model 116 can be updated periodically). In some examples, the version number can include the latest usable model version for specific factorized models.

In stage D, the client device 110 sends a context-based digital component request to a trusted server 120. The context-based digital component request can include the contextual data of the digital component request received from the application 112 and information about generating the user data factor. The information about generating the user data factor can include a version number determined based on the user data factor. The context-based digital component request can be transmitted by the client device 100 in response to receiving the request for the digital component from the application 112. In some implementations, the context-based digital component request sent by a client device 110 can include sensitive user data related to a user of the client device 110 and/or non-sensitive data. For example, the sensitive user data can include the user's age, user's gender, geolocation, the IP address, and/or a user history (e.g., what websites the user has visited, what the user has bought in the past, personal interests, such as music interests). The non-sensitive data can include keywords related the digital component request from the application 112 and/or anonymized user data. In some implementations, the context-based digital component request does not include the sensitive user data.

The trusted server 120 can be implemented using one or more server computers (or other appropriate computing devices), that may be distributed across multiple locations. In some implementations, the trusted server 120 can receive requests for digital components from client devices 110, select digital components based on data included in the requests, and send the selected digital components to the client devices 110. The trusted server 120 can run in a trusted execution environment (TEE). The TEE can include a secure environment in which software can execute in isolation (e.g., without being observed or modified) and data can be protected (e.g., encrypted). Communications between the TEE and other devices can be encrypted.

As the trusted server 120 receives sensitive user data, the trusted server 120 can be operated and maintained by an independent trusted party, e.g., a party that is different from the users of the client devices, the parties that operate the SSPs 140 and DSPs 150, and the digital component providers 160. For example, the trusted server 120 can be operated by an industry group or a governmental group.

In stage E, the trusted server 120 sends a context-based digital component request to an SSP 140. The trusted server 120 can forward the contextual data of the digital component request received from the client device 110. In some implementations, the trusted server 120 can receive user data from the client device 110 and temporarily store the user data while waiting for a response from the SSP 140. The trusted server 120 can send the context-based digital component request to an SSP 140 for the publisher of the resource being presented by the application 112.

In this example, user data does not cross a trust boundary that separates the client device 110, the trusted server 120, and the digital component repository 130 from the SSP 140, DSP 150, and digital component providers 160. In this way, no entity other than the client device 110 and the trusted server 120 (i.e., entities on the left, or trusted, side of the trust boundary) receives the user data that is included in a digital component request. This preserves user privacy and data security, especially when compared to techniques that employ third party cookies to send user data across the Internet.

An SSP 140 is a technology platform implemented in hardware and/or software that automates the process of obtaining digital components for the resources. Publishers of resources can use an SSP 140 to manage the process of obtaining digital components for digital component slots of its resources. Each publisher can have a corresponding SSP 140 or multiple SSPs 140. Some publishers may use the same SSP 140.

In stage F, the SSP 140 forwards the context-based digital component request to one or more DSPs 150. A DSP 150 is a technology platform implemented in hardware and/or software that automates the process of distributing digital components for presentation with the resources and/or applications. A DSP 150 can interact with multiple supply-side platforms SSPs on behalf of digital component providers 160 to provide digital components for presentation with the resources of multiple different publishers. Digital component providers 160 can create (or otherwise publish) digital components that are presented in digital component slots of publisher's resources.

In stage G, each DSP 150 sends, to the SSP 140, one or more selection parameters for one or more digital components, e.g., digital components stored in the digital component repository 130. For example, the DSP 150 can select a digital component based on the contextual data of the context-based request and determine a selection parameter for the digital component based on the contextual data. The DSP 150 can also provide a digital component and selection parameter, e.g., a digital component that is not stored in the digital component repository 130. The digital component providers 160 can provide new digital components to the DSPs to distribute to client devices. DSPs can store a larger number of digital components than the component repository 130. Each DSP 150 can send a selection parameter with data indicating the digital component to which the selection parameter applies. The digital components for which selection parameters are provided by the DSP 150 can be referred to as context-based digital components.

In stage H, the SSP 140 sends the digital components and/or selection values to the trusted server 120. In some implementations, the SSP 140 can filter digital components and/or selection parameters prior to sending the digital components and/or selection values to the trusted server 120. For example, the SSP 140 can filter digital components and/or selection parameters based on publisher controls specified by the publisher of the resource being presented by the application 112. In a particular example, a publisher of a web page about a particular event may define, as a publisher control, that digital components related to another event may not be presented with this web page. The SSP 140 can filter based on rules or other data provided by the publisher.

In stage I, the trusted server 120 queries the digital component repository 130 for a set of user-based digital components that are selected based on the user data of the digital component request. For example, the trusted server 120 can submit a query that defines, as conditions of the query, the user data of the digital component request. In some implementations, the query can also include context-based conditions. For example, a query can request retrieval of digital components that include, as distribution criteria, a particular user group and/or a particular geographic location. Although shown after stages E to H, the trusted server 120 can query the digital component repository in parallel with these stages to reduce the latency in selecting and providing a digital component to the application 112.

In some implementations, the trusted server 120 can select a digital component from a set of digital components stored in a digital component repository 130 and/or a set of digital components received from an SSP 140. The digital component repository 130 can store digital components received from content platforms (for example, from SSPs 140 and/or DSPs 150) and additional data for each digital component. Digital components received from content platforms can be stored in the digital component repository 130 so that they can quickly be provided to client devices in a trusted manner in response to future requests from the client devices.

In stage J, the trusted server 120 receives a set of user-based digital components from the digital component repository 130 and a digital component selection factor for each user-based digital components. The set of user-based digital components can include those having distribution criteria that matches the conditions of the query.

In some implementations, a selection engine 122 of the trusted server 120 can select a digital component to provide to the application 112 for presentation in the digital component slot. The selection engine 122 can select a digital component from the set of context-based digital components and the user-based digital components. The selection engine 122 can select the digital components from the two sets based on the selection parameter for each digital component in the two sets. For example, the selection engine 122 can select the digital component having the highest selection parameter. The selection engine 122 can select the digital components based on properties of the application 112 (e.g., a transportation application, a gaming application, a shopping application). Digital components corresponding to the properties of the application 112 can have a higher selection parameter.

In stage K, the trusted server 120 provides the selected digital component and/or selection values to the client device 110. For example, when the selection engine 122 selects a digital component, the trusted server 120 can transmit the digital component to the client device 110. In some examples, the selection engine 122 can forward selection values received from the SSP 140 to the client device 110. The selection values can include a contextual selection factor. The contextual selection factor can correspond to the version number of the model 116. The contextual selection factors can include query embeddings for specific factorized models. The contextual selection factors can be inferenced on server side with data only available on the SSP 140 or DSP 150 servers, e.g., publisher data, first party user data.

In stage L, the client device 110 queries the digital component repository 118 for a set of user-based digital components that are selected based on the user data of the digital component request. For example, the client device 110 can submit a query that defines, as conditions of the query, the user data corresponding to the digital component request. In some implementations, the query can also include context-based conditions. For example, a query can request retrieval of digital components that include, as distribution criteria, a particular user group (e.g., age group, income group) and/or a particular geographic location (e.g., IP address). Although shown after stages D to K, the client device 110 can query the digital component repository 118 in parallel with these stages to reduce the latency in selecting and providing a digital component to the application 112.

In stage M, the selection engine 114 receives a set of user-based digital components from the digital component repository 118 and a digital component selection factor for each of the user-based digital components. The set of user-based digital components can include those having distribution criteria that matches the conditions of the query. The selection engine 114 can fetch the corresponding version of the digital component selection factors, which can be preloaded from the server.

The selection engine 114 can select digital components based on corresponding digital component selection factors, contextual selection factors, and user data factors. The contextual selection factors can be received from the trusted server 120. The user data factor can be received from the model 116 and remain private, e.g., private user data does not cross the trust boundary. The selection engine 114 can select digital components by generating a score for each of the digital components based on the corresponding digital component selection factors, the contextual selection factor, and the user data factor. The selection engine 114 can select the digital component with the highest score.

In some implementations, a generated score can be derived from a dot product of multiple embedding vectors. The digital component selection factor, the contextual selection factor, and the user data factor, for example, can each be embedding vectors of equal dimension, and the generated score can be derived from a dot product that has been calculated from the three vectors. As another example, a linear transformation can be applied to the dot product (e.g., by multiplying the dot product by a scaling factor, adding an offset, or applying another sort of linear transformation). As another example, a configurable lambda function can be used to transform dot product results (e.g., when a desired transformation is non-linear). For example, a provider of digital components can define a lambda function in a high-level programming language, which is compiled into byte code to speed up execution and to provide a layer of obfuscation for confidentiality purposes. The byte code, for example, can be executed in a sandboxed virtual machine. The lambda function, for example, can be used to transform dot products for all candidate digital components for a content provider, or a subset of the candidate digital components (e.g., components in a defined group). Lambda functions that operate within the trust boundary, for example, may accept as input the user data, in addition to the dot product results.

In stage N, the client device 110 provides the selected digital component to the application 112. The application 112 can then present the digital component with the resource being presented by the application 112. In some implementations, the trusted server 120 can transmit a contextual response that includes digital component selection factors and contextual selection factors. The contextual response can cause the client device 110 to select a digital component using the digital component selection factors, the contextual selection factors, and user data factors.

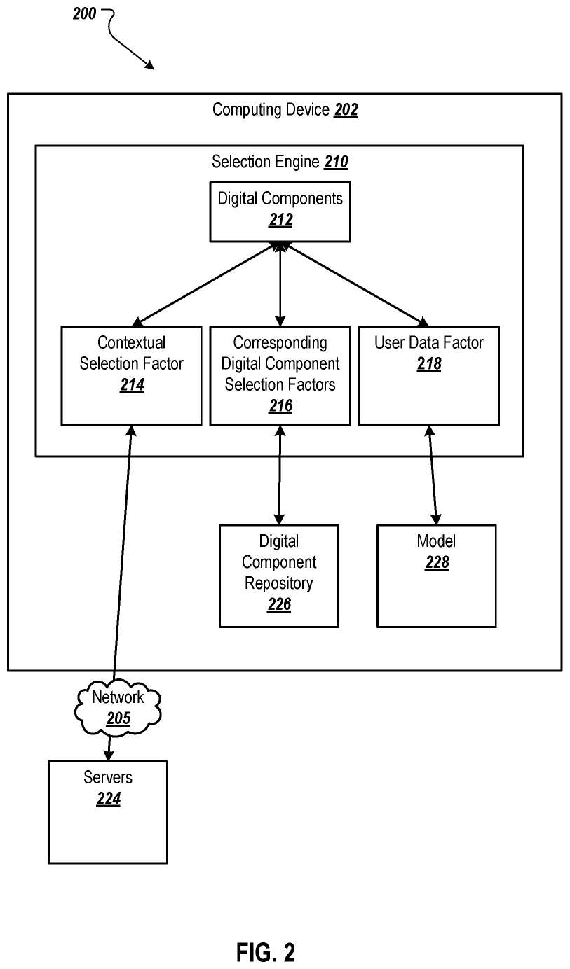

FIG. 2 is a block diagram of an example environment 200 in which a client device 202 selects digital components 212. The environment 200 includes servers 224, e.g., multi-platform server(s). The servers 224, for example, can be similar to the trusted server 120 (shown in FIG. 1). The example environment 200 includes data communication network(s) 205 (e.g., similar to data communication network 105, shown in FIG. 1) that connects client device 202 (for example, similar to client devices 110, also shown in FIG. 1) to the servers 224.

The client device 202 includes selection engine 210 (e.g., similar to selection engine 114, shown in FIG. 1), digital component repository 226 (e.g., similar to digital component repository 118, also shown in FIG. 1), and model 228 (e.g., similar to model 116, also shown in FIG. 1). The selection engine 210 can determine digital components 212 based on digital component selection factor 214, contextual selection factor 216, and user data factor 218. The digital component selection factor 214, contextual selection factor 216, and user data factor 218 can each include an embedding vector. The selection engine 210 can determine a dot product of the embedding vectors for a plurality of digital components, for example, stored in digital component repository 226. The selection engine 210 can receive the digital component selection factor 214 from servers 224. The selection engine 210 can receive the contextual selection factor 216 from the digital component repository 226. The selection engine 210 can receive the user data factor 218 from the model 228. For example, the model 228 can generate the user data factor 218 based on a request for a digital component.

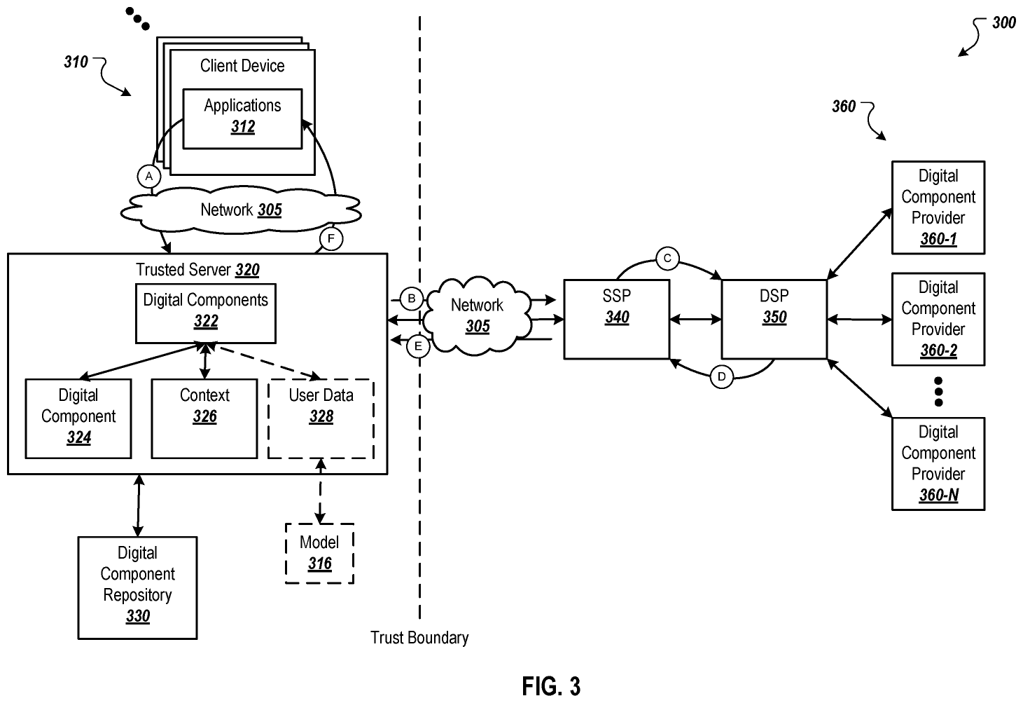

FIG. 3 is a block diagram of a first example environment 300 in which a trusted server 320 distributes digital components to client devices 310 in a privacy preserving manner. The environment 300 includes a data communication network 305 (e.g., data communication network 105, shown in FIG. 1). The data communication network 305 connects client devices 310 to the trusted server 320 and connects the trusted server 320 to content platforms, such as supply side platforms (SSPs) 340 and/or demand side platforms (DSPs 350). The network 305 can also connect the various content platforms to one another and/or to digital component providers 360 (e.g., to servers of the digital component providers 360).

The trusted server 320 can include a set of servers that serve personal ads and corresponding metadata (e.g., embeddings), or handles data from contextual calls. The trusted server 320 can include a factorized model for determining digital components 322. In some implementations, the trusted server 320 can include a two tower model for scoring digital components. For example, the trusted server 320 can select the digital components 322 using digital component embeddings 322 and context embeddings 324. In some implementations, the trusted server 320 can include a three tower model for scoring digital components. For example, the three tower model can include digital component embeddings 324, context embeddings 326, and user data embeddings 328. The trusted server 320 can select the digital components 322 using the three tower model.

The environment 300 can optionally include a model 316. For example, when the trusted server 320 includes a three tower model, the trusted server 320 can receive user data embeddings 328 from the model 316. The model 316 can include a trained machine learning model.

In some implementations, the trusted server 320 can include a two tower model. For example, the two tower model can include digital component embeddings 324 and context embeddings 326, and the trusted server 320 can select the digital components 322 using the two tower model.

The trusted server 320 can select a digital component from a set of digital components stored in a digital component repository 330 and/or a set of digital components received from an SSP 340 (e.g., digital components newly uploaded by the digital content providers 360). The digital component repository 330 stores digital components received from content platforms (e.g., from SSPs 340 and/or DSPs 350) and digital component embeddings for each digital component.

An example process for selecting and providing a digital component for presentation at a client device 310 is illustrated in stages A to F, which illustrate a flow of data between the components of the environment 300.

In stage A, the application 312 sends a digital component request to the trusted server 320. The application 312 can send a digital component request to request a digital component for presentation in a digital component slot of a resource being presented by the application 312. The digital component request can include user data and contextual data.

In stage B, the trusted server 320 sends a context-based digital component request to an SSP 340. The context-based digital component request can include the contextual data of the digital component request received from the application 312. However, the context-based digital component request does not include any of the user data. The trusted server 320 can temporarily store the user data while waiting for a response from the SSP 340. The trusted server 320 can send the context-based digital component request to an SSP 340 for the publisher of the resource being presented by the application 312.

In stage C, the SSP 340 forwards the context-based digital component request to one or more DSPs 350. In stage D, each DSP 350 sends, to the SSP 340, one or more selection factors for one or more digital components, e.g., digital components stored in the digital component repository 330. For example, the DSP 350 can select a digital component based on the contextual data of the context-based request and determine a selection factor for the digital component based on the contextual data. The DSP 350 can also provide a digital component and selection factor, e.g., a digital component that is not stored in the digital component repository 330. Each DSP 350 can send a selection factor with data indicating the digital component to which the selection factor applies. The digital components for which selection factors are provided by the DSPs 350 can be referred to as context-based digital components.

In stage E, the SSP 340 sends the digital components and/or selection factors to the trusted server 320. In some implementations, the SSP 340 can filter digital components and/or selection factors prior to sending the digital components and/or selection values to the trusted server 320. For example, the SSP 340 can filter digital components and/or selection factors based on publisher controls specified by the publisher of the resource being presented by the application 312. In a particular example, a publisher of a web page about a particular event may define, as a publisher control, that digital components related to another event may not be presented with this web page. The SSP 340 can filter based on rules or other data provided by the publisher.

The trusted server 320 can receive a plurality of digital component selection factors from multiple content platforms across a trust boundary. Each digital component selection factor can correspond to a digital component.

The trusted server 320 can query the digital component repository 330 for a set of user-based digital components that are selected based on the user data of the digital component request. For example, the trusted server 320 can submit a query that defines, as conditions of the query, the user data of the digital component request. In some implementations, the query can also include context-based conditions. For example, a query can request retrieval of digital components that include, as distribution criteria, a particular user group and/or a particular geographic location.

The trusted server 120 can receive data identifying a set of user-based digital components from the digital component repository 330 and a selection factor for each user-based digital components. The set of user-based digital components can include those having distribution criteria that matches the conditions of the query. These user-based digital components and the context-based digital components can also be referred to as candidate digital components as they are candidates for selection by the trusted server 320 for distribution to the client device 310 from which the digital component request was received.

In stage F, the trusted server 320 provides the selected digital component to the application 312. The application 312 can then present the digital component with the resource being presented by the application 312.

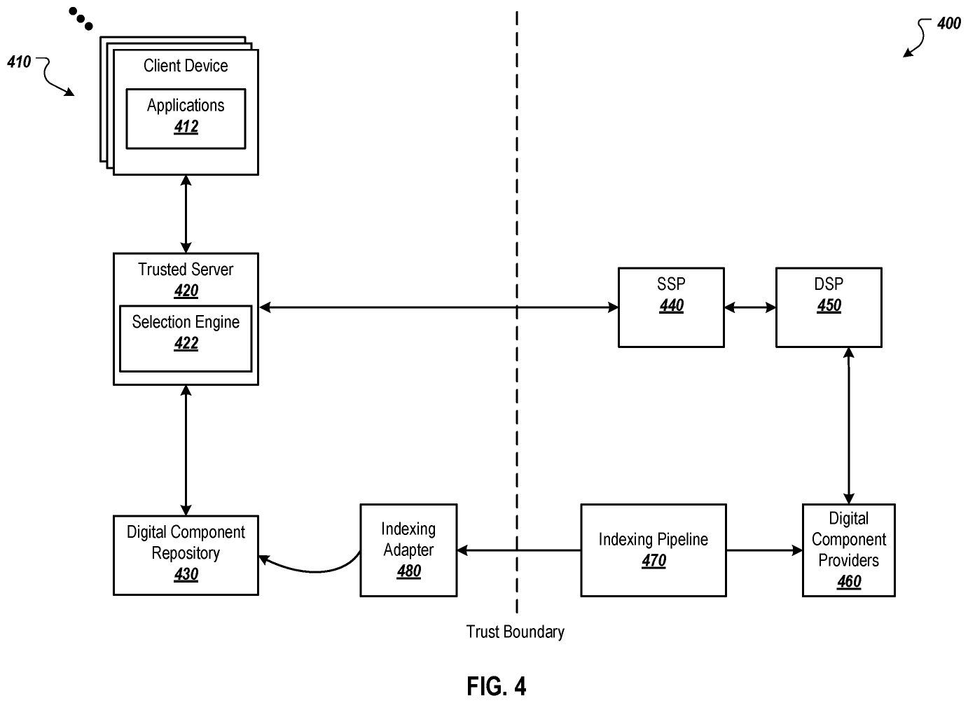

FIG. 4 is a block diagram of a second example environment 400 in which a trusted server 420 distributes digital components to client devices 410 in a privacy preserving manner. In the example environment 400, the trusted server 420 is connected to content platforms, such as supply side platforms (SSPs) 440 and/or demand side platforms (DSPs 450). The DSPs 450 can be connected to digital component providers 460 (e.g., to servers of the digital component providers 460).

The trusted server 420 can include a set of servers that serve personal ads and corresponding metadata (for example, embeddings), or handles data from contextual calls. The trusted server 420 can include a selection engine 422 for selecting digital components. The selection engine 422 can select a digital component from a set of digital components stored in a digital component repository 430 and/or a set of digital components received from an SSP 3440. The digital component repository 430 stores digital components received from content platforms (e.g., from SSPs 440 and/or DSPs 450) and digital component embeddings for each digital component.

The trusted server 420 can transmit the selected digital components to the client devices 410. The client devices 410 can then present the digital components within applications 412.

The digital component providers 460 can be connected to indexing pipeline 470, the indexing pipeline 470 can be connected to indexing adapter 480. The indexing pipeline 470 and the indexing adapter 480 can be used for offline digital component synchronization. For example, digital components can be synchronized before a request is received from the client devices 410 and quickly provided in a trusted manner in response to a request for a digital component. The indexing pipeline 470 and the indexing adapter 480 can transmit digital components and/or embedding across a trust boundary. For example, the digital component providers 460 can provide digital components and/or embeddings (e.g., query embeddings and ad embeddings) to the digital component repository 430 through the indexing pipeline 470 and the indexing adapter 480.

The selection ending 422 and client devices 410 can include factorized models. Versions of the models can be synchronized at pre-load time and/or at serving time. At pre-loading time, ad embeddings and models for user embeddings can be loaded into the client devices 410 synchronously or asynchronously. At a given time, the client devices 410 keep several versions for the prediction related data. Query embeddings can also be pre-loaded in the same way. At serving time, if query embeddings are pre-loaded, the client device can resolve the latest common version of all three types of embeddings. If query embeddings are not pre-loaded, the client device can resolve the latest common version of user and ad embeddings then fetch query embeddings with the resolved version.

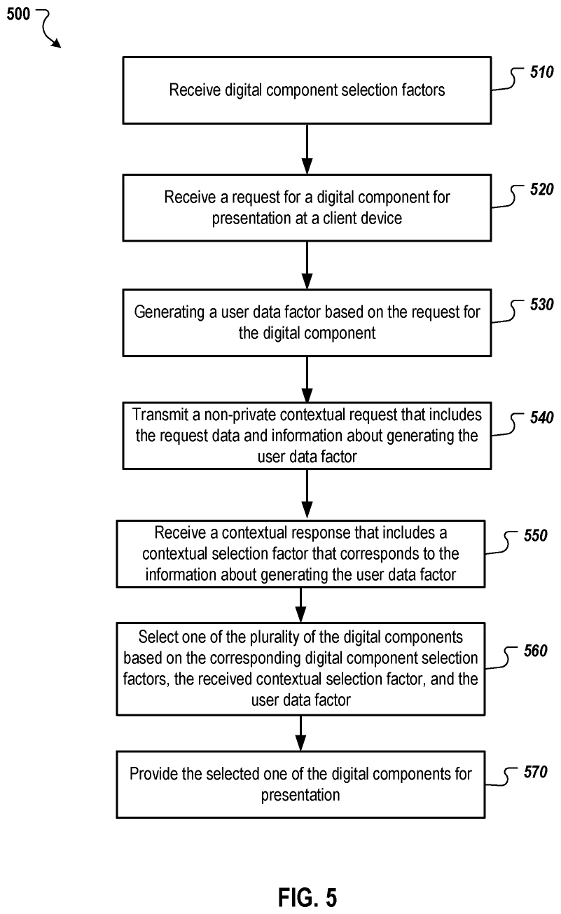

FIG. 5 is a flow diagram of an example process 500 for providing a digital component for display at a client device in a privacy preserving manner. Operations of the process 500 can be performed by a trusted serve (e.g., the trusted server 120 of FIG. 1), or a client device (e.g., the client device 110 of FIG. 1). Operations of the process 500 can also be implemented as instructions stored on one or more computer readable media, which may be non-transitory, and execution of the instructions by one or more data processing apparatus can cause the one or more data processing apparatus to perform the operations of the process 500.

A trusted computing device receives, from multiple content platforms across a trust boundary, a plurality of digital component selection factors that each correspond to a digital component of a plurality of digital components (510).

A trusted computing device receives a request for a digital component for presentation at a client device (520). The request can include request data.

The trusted computing device generates a user data factor (e.g., an embedding vector) based on the request for the digital component (530). The user data factor can be generated by a trained machine learning model using information from the digital component request. The trained machine learning model can be trained at least in part on the client device using historical user data. The trained machine learning model can be collaboratively trained with at least one other client device and the historical user data remains on the client device

The trusted computing device transmits, to at least one of the multiple content platforms across the trust boundary and in response to receiving the request for the digital component, a non-private contextual request that includes the request data and information about generating the user data factor (540). The information about generating the user data factor can include a version number determined based on the user data factor

The trusted computing device receives, from the at least one of the multiple content platforms across the trust boundary and after transmitting the non-private contextual request, a contextual response that includes a contextual selection factor that corresponds to the information about generating the user data factor (550).

The trusted computing device selects one of the plurality of the digital components based on the corresponding digital component selection factors, the received contextual selection factor, and the user data factor (560). The user data factor can remain private and not cross the trust boundary. For each of the digital components, the trusted computing device can generate a score based on the corresponding digital component selection factors, the contextual selection factor, and the user data factor. The trusted computing device can select the digital component with the greatest score. The digital component selection factor, the contextual selection factor, and the user data factor can each include embedding vectors of equal dimensions.

The trusted computing device can transmit a second contextual response that includes the corresponding digital component selection factors and the contextual selection factor. The second contextual response can cause the client device to select the one of the plurality of the digital components using the corresponding digital component selection factors, the contextual selection factor, and the user data factor.

The trusted computing device provides the selected one of the digital components for presentation (570).

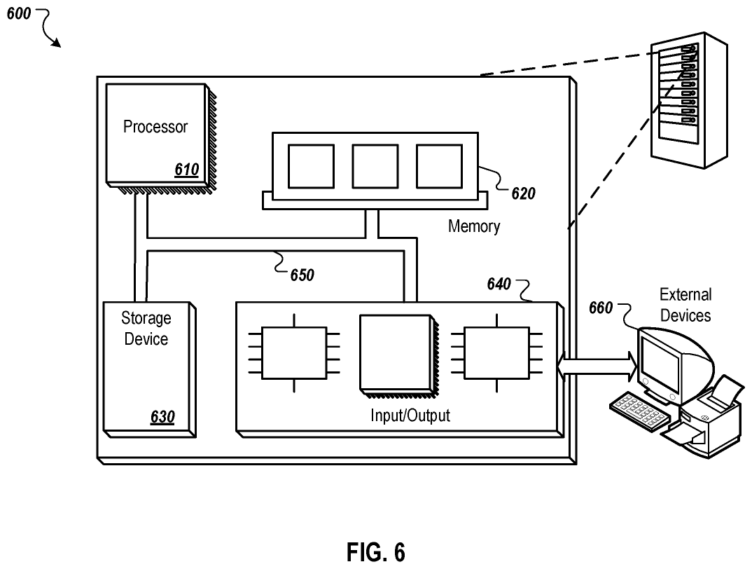

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In some implementations, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In some implementations, the memory 620 is a volatile memory unit. In another implementation, the memory 620 is a non-volatile memory unit.

The storage device 630 is capable of providing mass storage for the system 600. In some implementations, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In some implementations, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 660, e.g., keyboard, printer and display devices. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a client device and from multiple content platforms across a trust boundary, a plurality of digital component selection factors that each correspond to a digital component of a plurality of digital components, wherein the trust boundary defines one or more computing devices which can access private user data without the private user data being transmitted to untrusted third party devices;
receiving, by the client device, a request for a digital component for presentation at the client device, wherein the request includes request data;
generating, by the client device, a user data factor based on the request for the digital component;
in response to receiving the request for the digital component, transmitting, by the client device and to at least one of the multiple content platforms across the trust boundary, a non-private contextual request that includes the request data and information about generating the user data factor;
after transmitting the non-private contextual request, receiving, by the client device and from the at least one of the multiple content platforms across the trust boundary, a contextual response that includes a contextual selection factor that corresponds to the information about generating the user data factor;
selecting, by the client device, one of the plurality of the digital components based on the corresponding digital component selection factors, the received contextual selection factor, and the user data factor, wherein the user data factor remains private and does not cross the trust boundary; and
providing, by the client device, the selected one of the digital components for presentation.

2. The computer-implemented method of claim 1, wherein the information about generating the user data factor comprises a version number determined based on the user data factor.

3. The computer-implemented method of claim 1, wherein the user data factor is generated by a trained machine learning model using information from the digital component request.

4. The computer-implemented method of claim 3, wherein the trained machine learning model is trained at least in part on the client device using historical user data.

5. The computer-implemented method of claim 4, wherein the trained machine learning model is collaboratively trained with at least one other client device and the historical user data remains on the client device.

6. The computer-implemented method of claim 1, wherein selecting one of the digital components comprises:
for each of the digital components, generating a score based on the corresponding digital component selection factors, the contextual selection factor, and the user data factor; and
selecting the digital component with the greatest score.

7. The computer-implemented method of claim 1, wherein the digital component selection factor, the contextual selection factor, and the user data factor each comprise embedding vectors of equal dimensions.

8. A computer-implemented method comprising:
receiving, by at least one trusted computing device and from multiple content platforms across a trust boundary, a plurality of digital component selection factors that each correspond to a digital component of a plurality of digital components, wherein the trust boundary defines one or more computing devices which can access private user data without the private user data being transmitted to untrusted third party devices;
receiving, by the at least one trusted computing device, a request for a digital component for presentation at a client device, wherein the request includes request data;
generating, by the at least one trusted computing device, a user data factor based on the request for the digital component;
in response to receiving the request for the digital component, transmitting, by the at least one trusted computing device and to at least one of the multiple content platforms across the trust boundary, a non-private contextual request that includes the request data and information about generating the user data factor;
after transmitting the non-private contextual request, receiving, by the at least one trusted computing device and from the at least one of the multiple content platforms across the trust boundary, a contextual response that includes a contextual selection factor that corresponds to the information about generating the user data factor;
selecting, by the at least one trusted computing device, one of the plurality of the digital components based on the corresponding digital component selection factors, the received contextual selection factor, and the user data factor, wherein the user data factor remains private and does not cross the trust boundary; and
providing, by the at least one trusted computing device, the selected one of the digital components for presentation.

9. The computer-implemented method of claim 8, wherein selecting the one of the plurality of the digital components comprises transmitting, by a trusted server and to the client device, a second contextual response that includes the corresponding digital component selection factors and the contextual selection factor, wherein the second contextual response causes the client device to select the one of the plurality of the digital components using the corresponding digital component selection factors, the contextual selection factor, and the user data factor.

10. A system comprising:
one or more processors; and
one or more storage devices storing instructions that, when executed by the one or more processors, cause the one or more processor to carry out operations comprising:
receiving, by a client device and from multiple content platforms across a trust boundary, a plurality of digital component selection factors that each correspond to a digital component of a plurality of digital components, wherein the trust boundary defines one or more computing devices which can access private user data without the private user data being transmitted to untrusted third party devices;
receiving, by the client device, a request for a digital component for presentation at the client device, wherein the request includes request data;
generating, by the client device, a user data factor based on the request for the digital component;
in response to receiving the request for the digital component, transmitting, by the client device and to at least one of the multiple content platforms across the trust boundary, a non-private contextual request that includes the request data and information about generating the user data factor;
after transmitting the non-private contextual request, receiving, by the client device and from the at least one of the multiple content platforms across the trust boundary, a contextual response that includes a contextual selection factor that corresponds to the information about generating the user data factor;
selecting, by the client device, one of the plurality of the digital components based on the corresponding digital component selection factors, the received contextual selection factor, and the user data factor, wherein the user data factor remains private and does not cross the trust boundary; and
providing, by the client device, the selected one of the digital components for presentation.

11. (canceled)

12. (canceled)

13. The system of claim 10, wherein the information about generating the user data factor comprises a version number determined based on the user data factor.

14. The system of claim 10, wherein the user data factor is generated by a trained machine learning model using information from the digital component request.

15. The system of claim 14, wherein the trained machine learning model is trained at least in part on the client device using historical user data.

16. The system of claim 15, wherein the trained machine learning model is collaboratively trained with at least one other client device and the historical user data remains on the client device.

17. The system of claim 10, wherein selecting one of the digital components comprises:
for each of the digital components, generating a score based on the corresponding digital component selection factors, the contextual selection factor, and the user data factor; and
selecting the digital component with the greatest score.

18. The system of claim 10, wherein the digital component selection factor, the contextual selection factor, and the user data factor each comprise embedding vectors of equal dimensions.
